(19) United States
(12) Patent Application Publication
(10) Pub. No.: US 2026/0257926 A1
(43) Pub. Date: Sep. 3, 2026

(54) POWDER, AND PRODUCTION METHOD FOR POWDER

(71) Applicant: NISSHIN ENGINEERING INC., Tokyo (JP)

(72) Inventors: Shu WATANABE, Fujimino-city (JP); Tokisada MORITA, Fujimino-city (JP)

(21) Appl. No.: 19/165,442

(22) PCT Filed: Mar. 12, 2024
(86) PCT No.: PCT/JP2024/009630

§ 371 Date: Sep. 15, 2025

(30) Foreign Application Priority Data
Mar. 15, 2023 (JP) 2023-040757

(51) Int. Cl. C01B 35/10

(52) U.S. Cl. CPC C01B 35/1036; C01P 2002/72; C01P 2004/03; C01P 2004/62; C01P 2004/64

(57) ABSTRACT

Provided are powder containing crystalline boron oxide particles, and a production method capable of easily producing powder containing crystalline boron oxide particles with a small number of steps. Powder contains crystalline boron oxide particles having a degree of crystallinity of 20 to 100%. A production method of powder containing crystallized boron oxide particles includes a step of supplying a carrier gas in which powdered boron oxide is dispersed into a thermal plasma flame, and supplying a cooling gas to a termination part of the thermal plasma flame to generate the boron oxide particles.

### TECHNICAL FIELD

The present invention relates to powder containing crystalline boron oxide particles and a powder production method, and particularly relates to a powder production method for easily producing powder containing crystalline boron oxide particles.

### BACKGROUND ART

Currently, various kinds of fine particles are used for different applications. For example, fine particles such as metal fine particles, oxide fine particles, nitride fine particles, and carbide fine particles are used for electrical insulating materials such as various electrical insulating components, cutting tools, materials for machining, functional materials for sensors and the like, sintered materials, electrode materials for fuel cells, and catalysts.

Among the above fine particles, a production method of boron oxide fine particles is proposed in Patent Literature 1.

Patent Literature 1 shows a method for continuously producing a boron oxide product containing 85 to 92 wt % of B₂O₃, in which boric acid is fed onto a moving belt, conveyed through a heating zone, and heated to a temperature in a range of 220° C. to 275° C. for a sufficient period of time so that the boric acid is dehydrated to form molten glass containing 85 to 92 wt % of B₂O₃, and the molten glass is cooled to form a solid glassy product, which is then removed from the moving belt and is ground to form a granular amorphous boron oxide product containing 85 to 92 wt % of B₂O₃.

### CITATION LIST

### Patent Literatures

Patent Literature 1: JP 3718535 B

### SUMMARY OF INVENTION

### Technical Problems

The method for forming a granular amorphous boron oxide product of Patent Literature 1 has a large number of steps and requires a large amount of time for production. In addition, a crystallized boron oxide product cannot be obtained.

An object of the present invention is to provide powder containing crystalline boron oxide particles. Another object of the present invention is to provide a production method capable of easily producing powder containing crystalline boron oxide particles with a small number of steps.

### Solution to Problems

To attain the above-described object, an embodiment of the present invention is powder containing crystalline boron oxide particles having a degree of crystallinity of 20 to 100%.

The crystalline boron oxide particles preferably have a particle size of 20 to 800 nm.

An embodiment of the present invention is a production method of powder containing crystallized boron oxide particles, the production method including a step of generating boron oxide particles by supplying a carrier gas in which powdered boron oxide is dispersed into a thermal plasma flame.

For instance, the step of generating the boron oxide particles includes supplying the carrier gas in which the powdered boron oxide is dispersed into the thermal plasma flame, and then supplying a cooling gas to a termination part of the thermal plasma flame to generate the boron oxide particles.

The cooling gas is preferably argon gas, helium gas, oxygen gas, or nitrogen gas.

A plasma gas of the thermal plasma flame is preferably argon gas, helium gas, oxygen gas, or nitrogen gas.

### Advantageous Effects of Invention

According to the present invention, it is possible to provide powder containing crystalline boron oxide particles.

According to the present invention, it is also possible to easily produce the powder containing crystalline boron oxide particles with a small number of steps.

### BRIEF DESCRIPTION OF DRAWINGS

FIG. 1 is a schematic view illustrating an example of a fine particle production apparatus used in a production method of powder containing crystalline boron oxide particles of the present invention.

FIG. 2 is an X-ray diffraction diagram showing an example of an X-ray diffraction result of the powder containing crystalline boron oxide particles of the invention.

FIG. 3 is a schematic view showing an SEM image of the powder containing crystalline boron oxide particles of Example 1.

### DESCRIPTION OF EMBODIMENTS

Hereinafter, powder and a powder production method of the present invention will be described in detail based on preferred embodiments illustrated in the accompanying drawings.

Note that the drawings described below are exemplary for describing the invention, and are simplified for describing the invention. Therefore, the invention is not limited to the drawings described below.

Hereinafter, a numerical range indicated with use of “to” includes numerical values described before and after “to”. For example, when ε is from a numerical value ε_{α} to a numerical value ε_{β}, the range of ε is a range including the numerical values ε_{α} and ε_{β}, and is expressed mathematically as ε_{α}≤ε≤ε_{β}.

In addition, various numerical values include error ranges generally acceptable in the corresponding technical field unless otherwise specified.

### Fine Particle Production Apparatus

Hereinafter, an example of a production method of powder containing crystalline boron oxide particles of the present invention will be described.

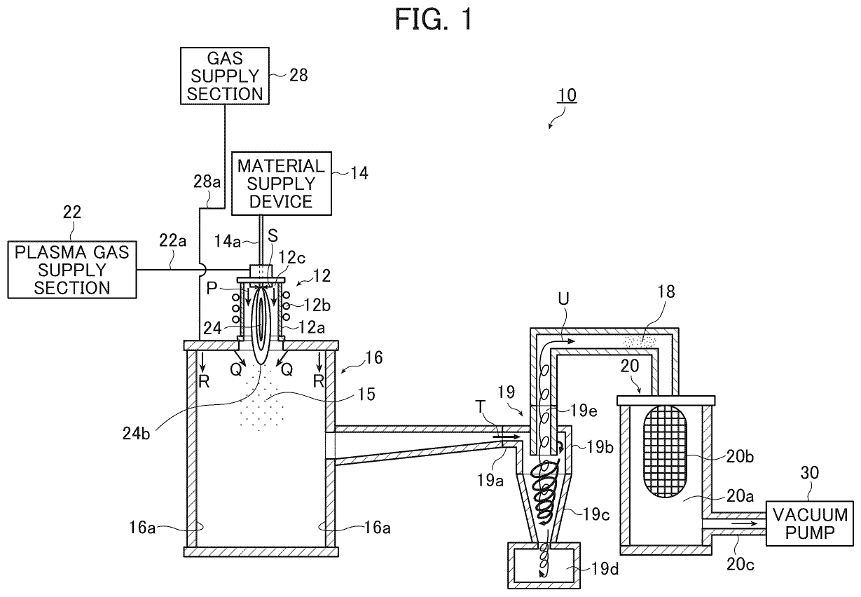

FIG. 1 is a schematic view illustrating an example of a fine particle production apparatus used in the production method of the powder containing crystalline boron oxide particles of the invention. A fine particle production apparatus 10 (hereinafter, simply referred to as a production apparatus 10) illustrated in FIG. 1 is used for producing the powder containing crystalline boron oxide particles. The production of the powder containing crystalline boron oxide particles is not limited to the production method employing the fine particle production apparatus 10 illustrated in FIG. 1. Hereinafter, the powder containing crystalline boron oxide particles is also simply referred to as the powder.

The production apparatus 10 includes a plasma torch 12 that generates thermal plasma, a material supply device 14 that feeds powdered feedstock for the powder into the plasma torch 12, a chamber 16 that functions as a cooling tank for generating primary fine particles 15, a cyclone 19 that removes coarse particles having a particle size equal to or larger than an arbitrarily defined particle size from the primary fine particles 15, and a collecting section 20 that collects secondary fine particles 18 classified by the cyclone 19 and having a desired particle size. The secondary fine particles 18 correspond to the “powder containing crystalline boron oxide particles” of the invention.

As the material supply device 14, the chamber 16, the cyclone 19, and the collecting section 20, for example, various devices in JP 2007-138287 A can be used.

In this embodiment, the production of the powder employs, for example, powdered boron oxide as the powdered feedstock. The powdered boron oxide is, for example, amorphous, but is not limited thereto. The powdered boron oxide may contain crystalline boron oxide other than amorphous boron oxide.

The powdered boron oxide has an average particle size that is appropriately set so that it is easily evaporated in a thermal plasma flame, and the average particle size is measured using a laser diffraction method. The average particle size is preferably 10 μm or more and 200 μm or less in consideration of handleability and feedability to a thermal plasma flame of the powdered boron oxide (powdered feedstock). The powdered boron oxide (powdered feedstock) more preferably has an average particle size of 20 μm or more and 150 μm or less because it can be evaporated regardless of the state of a thermal plasma flame and allows easy handling.

The plasma torch 12 is composed of a quartz tube 12a and a coil for high-frequency oscillation 12b surrounding the outside of the quartz tube. The plasma torch 12 is provided with a supply tube 14a, which will be mentioned later, on the top of the plasma torch 12 at the central part thereof for supplying powdered feedstock for the powder into the plasma torch 12. The supply tube 14a is provided with a plasma gas supply port 12c formed on the peripheral portion (along the same circumference), and the plasma gas supply port 12c has a ring shape. The coil for high-frequency oscillation 12b is connected to a power supply (not illustrated) that generates a high-frequency voltage. Application of a high-frequency voltage to the coil for high-frequency oscillation 12b generates a thermal plasma flame 24.

A plasma gas supply section 22 supplies a plasma gas into the plasma torch 12. The plasma gas supply section 22 is connected to the plasma gas supply port 12c via a pipe 22a. The plasma gas supply section 22 is provided with a supply flow controller such as a valve, which is not illustrated, for controlling the amount of gas supplied. The plasma gas is supplied into the plasma torch 12 from the plasma gas supply section 22 through the ring-shaped plasma gas supply port 12c from directions indicated by an arrow P and indicated by an arrow S.

As the plasma gas, for example, argon gas, helium gas, oxygen gas, or nitrogen gas is used. In this case, argon gas, helium gas, oxygen gas, or nitrogen gas is stored in the plasma gas supply section 22. From the plasma gas supply section 22, argon gas, helium gas, oxygen gas, or nitrogen gas is supplied into the plasma torch 12 via the pipe 22a through the plasma gas supply port 12c from directions indicated by the arrow P and indicated by the arrow S.

As the plasma gas, a plasma gas appropriate for the powder containing crystalline boron oxide particles is used. The plasma gas is not limited to one kind among the above-mentioned gases, and two or more kinds thereof may be mixed.

Application of a high-frequency voltage to the coil for high-frequency oscillation 12b generates the thermal plasma flame 24 in the plasma torch 12. The thermal plasma flame 24 evaporates the powdered feedstock (not illustrated) into a mixture in the gas phase.

The temperature of the thermal plasma flame 24 needs to be higher than the boiling point of the powdered feedstock. Meanwhile, as the temperature of the thermal plasma flame 24 is higher, the powdered feedstock is more easily brought into the gas phase, which is preferable, but the temperature is not particularly limited. For example, the temperature of the thermal plasma flame 24 can be set to 6000° C., and the temperature may theoretically be up to about 10,000° C.

In addition, the pressure of the atmosphere in the plasma torch 12 is preferably equal to or lower than atmospheric pressure. Here, the pressure of the atmosphere equal to or lower than atmospheric pressure is not particularly limited, and is, for example, 0.5 to 100 kPa.

The outside of the quartz tube 12a is surrounded by a concentrically formed tube (not illustrated), and cooling water is circulated between this tube and the quartz tube 12a to water-cool the quartz tube 12a, thereby preventing the quartz tube 12a from having an excessively high temperature due to the thermal plasma flame 24 generated in the plasma torch 12.

The material supply device 14 is connected to the top of the plasma torch 12 via the supply tube 14a. The material supply device 14 feeds, for example, powdered feedstock in the form of powder into the thermal plasma flame 24 in the plasma torch 12.

As the material supply device 14 that feeds the powdered feedstock in the form of powder, for example, a device disclosed in JP 2007-138287 A can be used as mentioned above. In this case, the material supply device 14 includes, for example, a storage tank (not illustrated) that stores the powdered feedstock, a screw feeder (not illustrated) that quantitatively conveys the powdered feedstock, a dispersion section (not illustrated) that disperses the powdered feedstock conveyed by the screw feeder into a state of primary particles before the powdered feedstock is finally injected, and a carrier gas supply source (not illustrated).

The powdered feedstock is fed into the thermal plasma flame 24 in the plasma torch 12 via the supply tube 14a together with a carrier gas to which the extrusion pressure is applied from the carrier gas supply source.

The configuration of the material supply device 14 is not particularly limited as long as it can prevent aggregation of the powdered feedstock and inject the powdered feedstock into the plasma torch 12 while maintaining the dispersion state. As the carrier gas, argon gas, helium gas, or nitrogen gas is used, for example. The carrier gas flow rate can be controlled using, for example, a flowmeter such as a float type flowmeter. The flow rate value of the carrier gas is a scale value of a flowmeter.

The chamber 16 is provided below and adjacent to the plasma torch 12, and a gas supply section 28 is connected to the chamber 16 via a pipe 28a. In the chamber 16, for example, primary fine particles 15 are generated. In addition, the chamber 16 functions as a cooling tank.

The gas supply section 28 supplies a cooling gas into the chamber 16 via the pipe 28a. The powdered feedstock is evaporated by the thermal plasma flame 24 into a mixture in the gas phase, to which the gas supply section 28 supplies a cooling gas (quenching gas) containing an inert gas. Similarly to the plasma gas, for example, argon gas, helium gas, oxygen gas, or nitrogen gas can be used as the cooling gas (quenching gas).

The gas supply section 28 is connected to the chamber 16 via the pipe 28a.

The gas supply section 28 has a gas supply source (not illustrated) in which the cooling gas is stored and a pressure application means (not illustrated) that applies an extrusion pressure to the cooling gas to be supplied into the chamber 16. In addition, the gas supply section 28 is provided with a pressure control valve (not illustrated) that controls the amount of gas supplied from the gas supply source. When the cooling gas is argon, argon gas is stored in the gas supply source, for example. The pressure application means is, for example, a compressor or a blower.

The gas supply section 28 supplies argon gas as the cooling gas toward a tail part 24b of the thermal plasma flame 24, that is, the end of the thermal plasma flame 24 opposite to the plasma gas supply port 12c, that is, the termination part of the thermal plasma flame 24, for example, at an angle of 45°, in the direction of an arrow Q, and supplies the above-mentioned cooling gas from the top to the bottom along an inner wall 16a of the chamber 16, that is, in the direction of an arrow R shown in FIG. 1.

The cooling gas supplied from the gas supply section 28 into the chamber 16 quenches the gas phase mixture generated through evaporation by the thermal plasma flame 24, and thus the primary fine particles 15 are obtained. In addition to the above, the above-mentioned cooling gas has an additional action such as contribution to classification of the primary fine particles 15 in the cyclone 19.

If the primary fine particles 15 having been just generated collide with each other to form an aggregate and thus cause unevenness in particle size, this results in deterioration in quality. However, the cooling gas introduced in the direction of the arrow Q toward the tail part 24b (termination part) of the thermal plasma flame 24 dilutes the primary fine particles 15, thereby preventing the fine particles from colliding with each other and aggregating.

In addition, the cooling gas in the direction of the arrow R prevents the primary fine particles 15 from adhering to the inner wall 16a of the chamber 16 in the process of collecting the primary fine particles 15, and the yield of the generated primary fine particles 15 is enhanced.

Although argon gas is used as the cooling gas (quenching gas), the cooling gas is not limited thereto, and nitrogen gas or the like can be used. Depending on production conditions, the cooling gas (quenching gas) may not be used. In this case, in the step of generating boron oxide particles, a carrier gas in which powdered boron oxide is dispersed is supplied into the thermal plasma flame to generate boron oxide particles.

As illustrated in FIG. 1, the chamber 16 is provided with the cyclone 19 for classifying the primary fine particles 15 with a desired particle size. The cyclone 19 includes an inlet pipe 19a that supplies the primary fine particles 15 from the chamber 16, a cylindrical outer shell 19b that is connected to the inlet pipe 19a and positioned in the upper part of the cyclone 19, a truncated conical part 19c that extends continuously from the lower part of the outer shell 19b toward the lower side, with its diameter decreasing gradually, a coarse particle collecting chamber 19d that is connected to the lower side of the truncated conical part 19c and collects coarse particles having a particle size equal to or larger than the desired particle size mentioned above, and an inner pipe 19e that is connected to the collecting section 20 mentioned in detail later and protrudes from the outer shell 19b.

An air flow containing the primary fine particles 15 is blown in from the inlet pipe 19a of the cyclone 19 along the inner peripheral wall of the outer shell 19b, whereby the air flow flows from the inner peripheral wall of the outer shell 19b toward the truncated conical part 19c, as indicated by an arrow T in FIG. 1, to form a descending swirling flow.

Then, when the above-mentioned descending swirling flow reverses and becomes an upward flow, the coarse particles cannot be entrained in the upward flow due to the balance between the centrifugal force and the drag force, but descend along the side face of the truncated conical part 19c, and are collected in the coarse particle collecting chamber 19d. The fine particles affected by the drag force rather than the centrifugal force are discharged from the inner pipe 19e to the outside of the cyclone 19 together with the upward flow on the inner wall of the truncated conical part 19c.

In addition, a negative pressure (suction force) is generated from the collecting section 20, which will be mentioned in detail later, through the inner pipe 19e. Then, this negative pressure (suction force) allows the fine particles separated from the above-mentioned swirling airflow to be sucked as indicated by a reference sign U and transported to the collecting section 20 through the inner pipe 19e.

The collecting section 20 that collects secondary fine particles (fine particles) 18 having a particle size of a desired nanometer order is provided on an extension of the inner pipe 19e, which is an outlet of the air flow in the cyclone 19. The collecting section 20 includes a collecting chamber 20a, a filter 20b provided in the collecting chamber 20a, and a vacuum pump 30 connected via a pipe 20c provided in the lower part of the collecting chamber 20a. The fine particles transported from the cyclone 19 are sucked by the vacuum pump 30 to be drawn into the collecting chamber 20a, and remain on the surface of the filter 20b and are then collected.

In the above-mentioned production apparatus 10, the number of cyclones used is not limited to one, and may be two or more.

### Production Method

Next, an example of a powder production method employing the above-mentioned production apparatus 10 will be described.

First, powdered boron oxide having an average particle size of 10 to 200 μm, for example, is used as the powdered feedstock for the powder.

For example, argon gas is used as the plasma gas, and a high-frequency voltage is applied to the coil for high-frequency oscillation 12b to generate the thermal plasma flame 24 in the plasma torch 12.

In addition, argon gas, for example, is supplied as the cooling gas from the gas supply section 28 to the tail part 24b of the thermal plasma flame 24, that is, the termination part of the thermal plasma flame 24, in the direction of the arrow Q. At this time, argon gas is supplied as the cooling gas in the direction of the arrow R.

Next, argon gas, for example, is used as the carrier gas to gas convey the powdered boron oxide as the feedstock and supply it into the thermal plasma flame 24 in the plasma torch 12 through the supply tube 14a. The powdered boron oxide thus supplied evaporates to be converted into the gas phase in the thermal plasma flame 24, and is rapidly cooled by the cooling gas to generate the primary fine particles 15.

Then, the primary fine particles 15 obtained in the chamber 16 are blown in from the inlet pipe 19a of the cyclone 19 along the inner peripheral wall of the outer shell 19b together with the air flow, whereby the air flow flows along the inner peripheral wall of the outer shell 19b, as indicated by the arrow T in FIG. 1, to form a swirling flow and descend. Then, when the above-mentioned descending swirling flow reverses and becomes an upward flow, the coarse particles cannot be entrained in the upward flow due to the balance between the centrifugal force and the drag force, but descend along the side face of the truncated conical part 19c, and are collected in the coarse particle collecting chamber 19d. The fine particles affected by the drag force rather than the centrifugal force are discharged from the inner wall of the truncated conical part 19c to the outside of the cyclone 19 together with the upward flow on the inner wall.

The discharged secondary fine particles 18 are sucked in a direction indicated by the reference sign U in FIG. 1 due to negative pressure (suction force) from the collecting section 20 by the vacuum pump 30, transported to the collecting section 20 through the inner pipe 19e, and collected by the filter 20b of the collecting section 20. The internal pressure of the cyclone 19 at this time is preferably equal to or lower than atmospheric pressure. As the particle size of the secondary fine particles (fine particles) 18, an arbitrary particle size on the order of nanometers is defined according to the purpose.

As mentioned above, the cooling gas (quenching gas) may not be used depending on production conditions. In this case, argon gas, for example, is used as the carrier gas to gas-convey the powdered boron oxide as the feedstock and supply it into the thermal plasma flame 24 in the plasma torch 12 through the supply tube 14a. The powdered boron oxide thus supplied evaporates to be converted into the gas phase in the thermal plasma flame 24, and is naturally cooled in the chamber 16 without a cooling gas to generate boron oxide particles.

### Powder

Next, the powder will be described.

The powder contains crystalline boron oxide particles having a degree of crystallinity of 20 to 100%.

In the powder, the content of the crystalline boron oxide particles is preferably 5 to 100 mass %.

The crystalline boron oxide particles preferably have a particle size of 20 to 800 nm, more preferably a particle size of 50 to 500 nm.

The above-mentioned particle size is an average particle size measured using the BET method. The particle size of the crystalline boron oxide particles is measured using Macsorb (registered trademark) HM-1208 manufactured by Mountech Co., Ltd.

The powder containing the crystalline boron oxide particles having a degree of crystallinity of 20 to 100% of the present invention is produced, for example, by the above-mentioned production method, and is obtained in the form of particles.

The powder containing the crystalline boron oxide particles having a degree of crystallinity of 20 to 100% of the present invention is not in a state of being dispersed in a solvent or the like but is independently present as particles. Therefore, it can be used in combination with various materials such as solvent.

### Crystalline Boron Oxide Particles

The crystalline boron oxide particles are particles having a diffraction pattern derived from boron oxide in an X-ray diffraction diagram measured using an X-ray diffraction (XRD) apparatus.

The degree of crystallinity is a value obtained by calculating the crystalline and amorphous peak areas from an X-ray diffraction diagram measured using an X-ray diffraction apparatus and defining by a crystalline peak area/(a crystalline peak area+an amorphous peak area). The crystalline peak area+the amorphous peak area corresponds to the total peak area.

Here, FIG. 2 is an X-ray diffraction diagram showing an example of an X-ray diffraction result for the powder containing the crystalline boron oxide particles of the invention. Specifically, an X-ray diffraction spectrum 40 of the X-ray diffraction diagram shown in FIG. 2 shows a spectrum of the powder containing the crystalline boron oxide particles, which has a diffraction pattern derived from boron oxide.

In the X-ray diffraction spectrum 40, a regions 42 corresponding to a crystalline peak area is a region including the diffraction peak of B₂O₃.

A region 44 corresponding to the amorphous peak area is a region corresponding to the halo pattern area of the X-ray diffraction spectrum 40.

The crystalline and amorphous peak areas mentioned above can be calculated using, for example, known analysis software for an X-ray diffraction spectrum. The degree of crystallinity is thereby obtained.

### Application

As an application of the powder containing the crystalline boron oxide particles of the present invention, for example, the powder can be used for a ferrite material. The ferrite material is suitably used for, for example, a multilayer inductor, a multilayer L-C filter, a multilayer common mode filter, a near field communication (NFC) coil, a multilayer impedance element, and a multilayer transformer.

The present invention is basically configured as described above. Although the powder and the powder production method of the invention have been described in detail above, the invention is not limited to the above-mentioned embodiments, and it is a matter of course that various improvements or changes may be made without departing from the gist of the invention.

### Examples

Hereinafter, the powder containing the crystalline boron oxide particles of the present invention will be described more specifically.

In this Example, an attempt was made to produce powder containing crystalline boron oxide particles (Example 1). Production of the powder containing crystalline boron oxide particles employs the production apparatus 10 illustrated in FIG. 1. The production conditions are shown below.

As a production condition, the average power applied to the coil for high-frequency oscillation 12b was constant at 9 kW. Ar gas was used as the plasma gas, and the flow rate of the Ar gas was set to 130 L/min (in terms of a standard state). The pressure in the plasma torch was fixed at 50 kPa. No quenching gas was used.

For the feedstock supply, Ar gas was used as the carrier gas, and powdered boron oxide having an average particle size of 80 μm was supplied at 2.5 g/min together with the carrier gas. The flow rate of the carrier gas was set to 10 L/min (in terms of a standard state). The average particle size of the boron oxide powder is a value measured with a particle size analyzer.

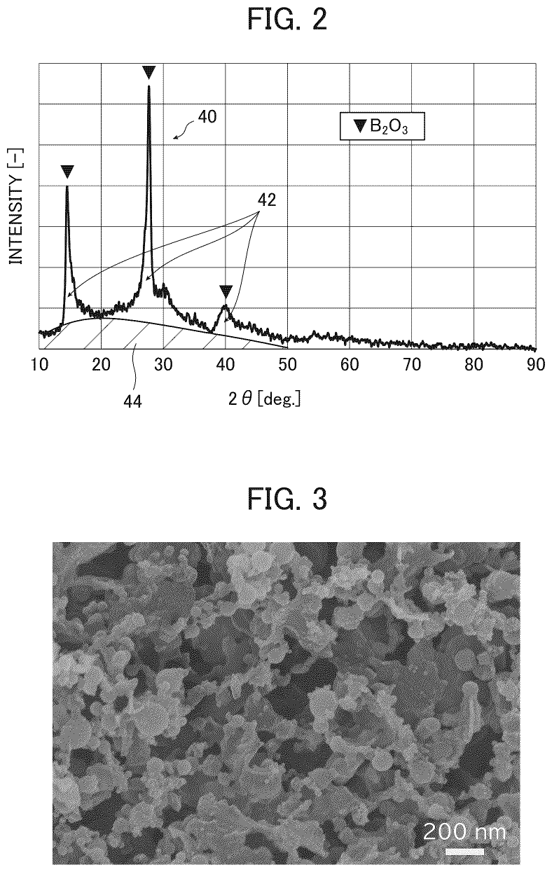

As a result, the powder shown in FIG. 3 was obtained. The powder shown in FIG. 3 was subjected to X-ray diffraction using an X-ray diffraction apparatus, as a result of which an X-ray diffraction spectrum as shown in FIG. 2 was obtained. The powder contained crystalline boron oxide particles.

The powder shown in FIG. 3 had a particle size of 102 nm as an average particle size measured using the BET method, and a degree of crystallinity of 28.9%.

### REFERENCE SIGNS LIST

10 fine particle production apparatus
12 plasma torch
14 material supply device
15 primary fine particles
16 chamber
18 secondary fine particles
19 cyclone
20 collecting section
22 plasma gas supply section
22a pipe
24 thermal plasma flame
24b tail part
28 gas supply section
28a pipe
30 vacuum pump
40 X-ray diffraction spectrum
42, 44 region

1. Powder containing crystalline boron oxide particles having a degree of crystallinity of 20 to 100%.

2. The powder according to claim 1, wherein the crystalline boron oxide particles have a particle size of 20 to 800 nm.

3. A production method of powder containing crystallized boron oxide particles, the production method comprising:
a step of generating boron oxide particles by supplying a carrier gas in which powdered boron oxide is dispersed into a thermal plasma flame.

4. The production method of powder according to claim 3,
wherein the step of generating the boron oxide particles includes supplying the carrier gas in which the powdered boron oxide is dispersed into the thermal plasma flame,
and then supplying a cooling gas to a termination part of the thermal plasma flame to generate the boron oxide particles.

5. The production method of powder according to claim 4, wherein the cooling gas is argon gas, helium gas, oxygen gas, or nitrogen gas.

6. The production method of powder according to claim 3, wherein a plasma gas of the thermal plasma flame is argon gas, helium gas, oxygen gas, or nitrogen gas.

7. The production method of powder according to any one of claims 4, wherein a plasma gas of the thermal plasma flame is argon gas, helium gas, oxygen gas, or nitrogen gas.

8. The production method of powder according to any one of claims 5, wherein a plasma gas of the thermal plasma flame is argon gas, helium gas, oxygen gas, or nitrogen gas.
